(19) United States
(12) Patent Application Publication
(10) Pub. No.: US 2025/0275620 A1
(43) Pub. Date: Sep. 4, 2025

(54) REPLACEABLE POWDER PALETTE

(71) Applicant: PPK (SHANGHAI) PACKAGING CO., LTD., Shanghai (CN)

(72) Inventor: Helin ZHOU, Shanghai (CN)

(73) Assignee: PPK (SHANGHAI) PACKAGING CO., LTD., Shanghai (CN)

(21) Appl. No.: 18/869,293

(22) PCT Filed: Mar. 29, 2023
(86) PCT No.: PCT/CN2023/084594

§ 371 Date: Nov. 26, 2024

(30) Foreign Application Priority Data
Dec. 9, 2022 (CN) 202223299280.X

(51) Int. Cl. A45D 33/24; A45D 33/00

(52) U.S. Cl. CPC A45D 33/24; A45D 33/008

(57) ABSTRACT

A replaceable powder palette is provided. The replaceable powder palette includes a dustproof cap, a flip cap, a replaceable container, and a base, where the dustproof cap covers the base; at least one use port is formed in the flip cap; the replaceable container is a top-opened case; the base is provided with an accommodating cavity; at least one small compartment is enclosed in the accommodating cavity through a retaining wall; the replaceable container is clamped on the retaining wall; the flip cap is hinged to the base and has a use position and an open position; the flip cap located at the use position presses the replaceable container, with the use port corresponding to an opening of the replaceable container; and when the flip cap is located at the open position, the replaceable container is in a dismountable state.

### CROSS-REFERENCE TO THE RELATED APPLICATIONS

This application is the national phase entry of International Application No. PCT/CN2023/084594, filed on Mar. 29, 2023, which is based upon and claims priority to Chinese Patent Application No. 202223299280.X, filed on Dec. 9, 2022, the entire contents of which are incorporated herein by reference.

### TECHNICAL FIELD

The present disclosure relates to the field of cosmetics, and in particular to a cosmetic container.

### BACKGROUND

At present, after a powder compact and a powder palette are used up, the packaging material is discarded completely and cannot be reused. The brand-new packaging material is extremely wasted. Moreover, the packaging material is non-degradable. A large number of discarded packaging materials will seriously pollute the environment.

### SUMMARY

### Technical Problem

A technical problem to be solved by the present disclosure is to provide a replaceable powder palette. According to the replaceable powder palette, after the material in the replaceable container is used up, the replaceable container can be discarded directly, without influences on the environment. Meanwhile, the small compartments on the base can be combined according to an actual demand to cooperate freely with various replaceable containers for use. Therefore, the present disclosure meets the demand on personalized customization, and has the extensive popularization and application values.

### Technical Solutions

The present disclosure is realized as follows: A replaceable powder palette includes a dustproof cap, a flip cap, a replaceable container, and a base, where the dustproof cap covers the base; at least one use port is formed in the flip cap; the replaceable container is a top-opened case; the base is provided with an accommodating cavity; at least one small compartment is enclosed in the accommodating cavity through a retaining wall; the replaceable container is clamped on the retaining wall; the flip cap is hinged to the base and has a use position and an open position; the flip cap located at the use position presses the replaceable container, with the use port corresponding to an opening of the replaceable container; and when the flip cap is located at the open position, the replaceable container is in a dismountable state.

A pair of fetching gaps are formed centrosymmetrically in the retaining wall.

There are a plurality of small compartments; and the plurality of small compartments are arranged on the base in a matrix.

Two adjacent ones of the plurality of small compartments are formed into one group; the retaining wall is divided by the pair of fetching gaps into two sections; fetching gaps in the retaining walls corresponding to two small compartments in a same group are respectively provided at same positions; and for the two small compartments in the same group, adjacent sections of the retaining walls are lower than sections of the retaining walls away from each other.

The replaceable container is made of a degradable material.

The base is a square case; the flip cap includes one side provided with a second hinge shaft, and the other side provided with a fastener; and a clamping groove matching the fastener is formed in the base.

One side of the dustproof cap is hinged to the base through a first hinge shaft; and the first hinge shaft and the second hinge shaft are a same shaft.

One side of the dustproof cap is hinged to the base through a first hinge shaft; and the first hinge shaft and the second hinge shaft are hinged to adjacent edges of the base.

A corner position of a side of the flip cap not provided with the second hinge shaft is further provided with an open groove.

An inner surface of the dustproof cap is further provided with a cosmetic mirror.

### Beneficial Effects

According to the replaceable powder palette provided by the present disclosure, after the material in the replaceable container is used up, the replaceable container can be discarded directly, without influences on the environment. Meanwhile, the small compartments on the base can be combined according to an actual demand to cooperate freely with various replaceable containers for use. Therefore, the present disclosure meets the demand on personalized customization, and has the extensive popularization and application values.

### BRIEF DESCRIPTION OF THE DRAWINGS

FIG. 1 is a schematic exploded view of parts of a replaceable powder palette according to the present disclosure;

FIG. 2 is a schematic sectional view according to the present disclosure;

FIG. 3 is a schematic structural view of a flip cap and a base according to the present disclosure;

FIG. 4 is a schematic perspective view when a flip cap is located at an open position according to Embodiment 1 of the present disclosure; and

FIG. 5 is a schematic perspective view when a flip cap is located at an open position according to Embodiment 2 of the present disclosure.

In the figures: 1: dustproof cap, 2: flip cap, 3: replaceable container, 4: base, 5: cosmetic mirror, 11: first hinge shaft, 21: use port, 22: second hinge shaft, 23: fastener, 24: open groove, 41: accommodating cavity, 42: retaining wall, 43: small compartment, 44: fetching gap, and 45: clamping groove.

### DETAILED DESCRIPTION OF THE EMBODIMENTS

The present disclosure will be further described below with reference to specific embodiments. It should be understood that these embodiments are only intended to describe the present disclosure, rather than to limit the scope of the present disclosure. In addition, it is to be understood that various changes and modifications can be made to the present disclosure by those skilled in the art after reading the materials of the present disclosure, and these equivalent forms also fall within the scope defined by the appended claims of the present disclosure.

### Embodiments

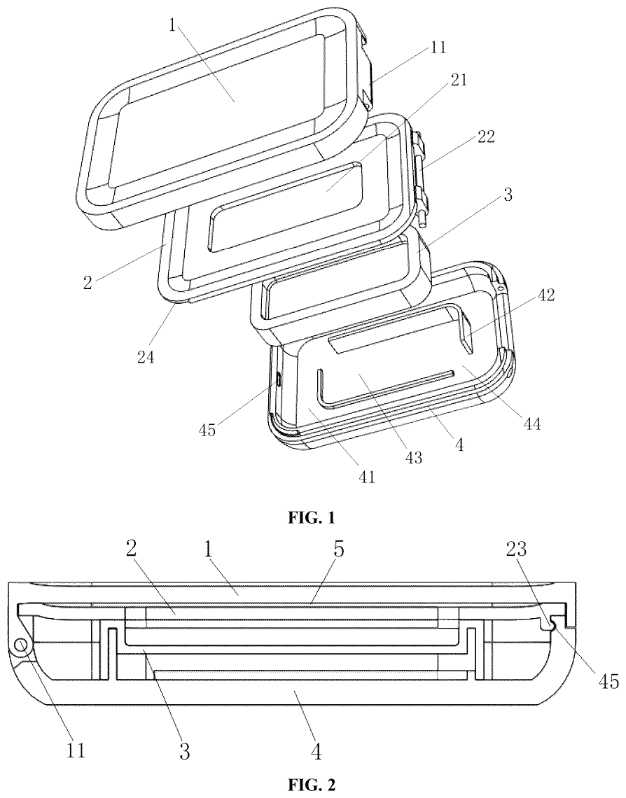

As shown in FIG. 1 and FIG. 2, a replaceable powder palette includes dustproof cap 1, flip cap 2, replaceable container 3, and base 4. The dustproof cap 1 covers the base 4. At least one use port 21 is formed in the flip cap 2. The replaceable container 3 is a top-opened case. The base 4 is provided with accommodating cavity 41. At least one small compartment 43 is enclosed in the accommodating cavity 41 through retaining wall 42. The replaceable container 3 is clamped on the retaining wall 42. The flip cap 2 is hinged to the base 4 and has a use position and an open position. The flip cap 2 located at the use position presses the replaceable container 3, with the use port 21 corresponding to an opening of the replaceable container 3. When the flip cap 2 is located at the open position, the replaceable container 3 is in a dismountable state.

In the present disclosure, in order to take out the replaceable container 3 conveniently for replacement, a pair of fetching gaps 44 are formed centrosymmetrically in the retaining wall 42.

Generally, in order to meet the actual use demand, there are a plurality of small compartments 43. The plurality of small compartments 43 are arranged on the base 4 in a matrix. In this way, replaceable containers 3 containing different components can be placed in the small compartments 43 respectively to meet the actual makeup demand.

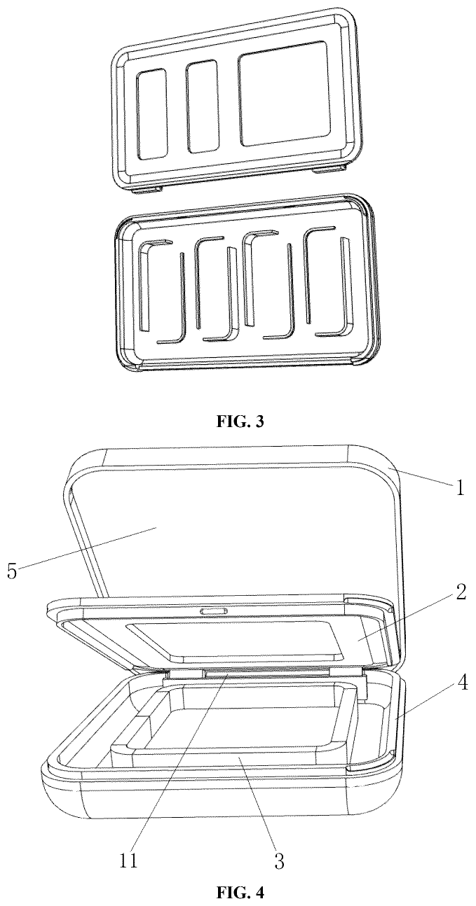

As shown in FIG. 3, in the present disclosure, in order to further meet the demand on personalized customization, two adjacent ones of the plurality of small compartments 43 are formed into one group. The retaining wall 42 is divided by the pair of fetching gaps 44 into two sections. Fetching gaps 44 in the retaining walls 42 corresponding to two small compartments 43 in a same group are respectively provided at same positions. For the two small compartments 43 in the same group, adjacent sections of the retaining walls 42 are lower than sections of the retaining walls 42 away from each other. In arrangement, the group of small compartments 43 may be combined into big replaceable container 3. After the two adjacent lower sections of the retaining walls each are assorted with the corresponding replaceable container, the placement and use of the big replaceable container are not affected.

In the present disclosure, the replaceable container 3 is made of a degradable material. The replaceable container 3 can be discarded directly, without influences on the environment. Generally, the degradable material is a paper material prepared from wood fibers, bamboo fibers, chitin fibers or polylactic acid fibers. The replaceable container 3 is formed integrally with a paper-making process, thereby reducing the production cost.

Further, the base 4 is a square case. The flip cap 2 includes one side provided with second hinge shaft 22, and the other side provided with fastener 23. Clamping groove 45 matching the fastener 23 is formed in the base 4.

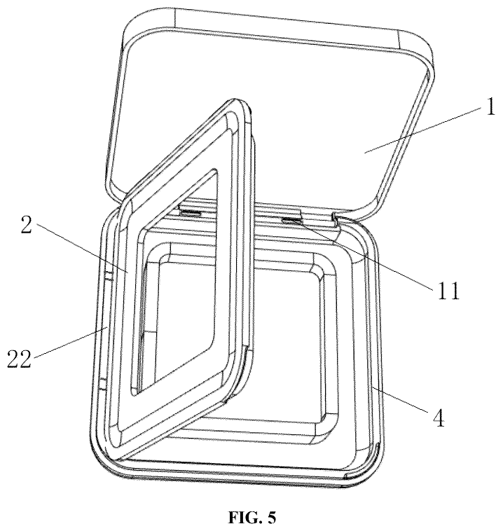

As shown in FIG. 4, in Embodiment 1, one side of the dustproof cap 1 is hinged to the base 4 through first hinge shaft 11. The first hinge shaft 11 and the second hinge shaft 22 are a same shaft. This achieves the simple structure, reduces the production cost, and simplifies the assembly process.

As shown in FIG. 5, in Embodiment 2, one side of the dustproof cap 1 is hinged to the base 4 through first hinge shaft 11. The first hinge shaft 11 and the second hinge shaft 22 are hinged to adjacent edges of the base 4. The first hinge shaft 11 and the second hinge shaft 22 that are separated do not interfere with each other in movement. This further meets the demand of the replaceable powder palette on replacement of the replaceable container 3.

In the present disclosure, in order to open the flip cap 2 conveniently, a corner position of a side of the flip cap 2 not provided with the second hinge shaft 22 is further provided with open groove 24. Meanwhile, in view of the demand on makeup, an inner surface of the dustproof cap 1 is further provided with cosmetic mirror 5.

What is claimed is:

1. A replaceable powder palette, comprising a dustproof cap, a flip cap, a replaceable container, and a base, wherein the dustproof cap covers the base; at least one use port is formed in the flip cap; the replaceable container is a top-opened case; the base is provided with an accommodating cavity at least one small compartment is enclosed in the accommodating cavity through a retaining wall; the replaceable container is clamped on the retaining wall; the flip cap is hinged to the base and has a use position and an open position; the flip cap located at the use position presses the replaceable container, with the at least one use port corresponding to an opening of the replaceable container; and when the flip cap is located at the open position, the replaceable container is in a dismountable state.

2. The replaceable powder palette according to claim 1, wherein a pair of fetching gaps are formed centrosymmetrically in the retaining wall.

3. The replaceable powder palette according to claim 2, wherein there are a plurality of small compartments; and the plurality of small compartments are arranged on the base in a matrix.

4. The replaceable powder palette according to claim 3, wherein two adjacent ones of the plurality of small compartments are formed into one group; the retaining wall is divided by the pair of fetching gaps into two sections; fetching gaps in the retaining walls corresponding to two small compartments in a same group are respectively provided at same positions; and for the two small compartments in the same group, adjacent sections of the retaining walls are lower than sections of the retaining walls away from each other.

5. The replaceable powder palette according to claim 1, wherein the replaceable container is made of a degradable material.

6. The replaceable powder palette according to claim 5, wherein the base is a square case; the flip cap comprises a first side provided with a second hinge shaft, and a second the other side provided with a fastener; and a clamping groove matching the fastener is formed in the base.

7. The replaceable powder palette according to claim 6, wherein one side of the dustproof cap is hinged to the base through a first hinge shaft; and the first hinge shaft and the second hinge shaft are a same shaft.

8. The replaceable powder palette according to claim 6, wherein one side of the dustproof cap is hinged to the base through a first hinge shaft; and the first hinge shaft and the second hinge shaft are hinged to adjacent edges of the base.

9. The replaceable powder palette according to claim 6, wherein a corner position of a side of the flip cap not provided with the second hinge shaft is further provided with an open groove.

10. The replaceable powder palette according to claim 5, wherein an inner surface of the dustproof cap is further provided with a cosmetic mirror.

11. The replaceable powder palette according to claim 2, wherein the replaceable container is made of a degradable material.

12. The replaceable powder palette according to claim 3, wherein the replaceable container is made of a degradable material.

13. The replaceable powder palette according to claim 4, wherein the replaceable container is made of a degradable material.

14. The replaceable powder palette according to claim 11, wherein the base is a square case; the flip cap comprises a first side provided with a second hinge shaft, and a second side provided with a fastener; and a clamping groove matching the fastener is formed in the base.

15. The replaceable powder palette according to claim 12, wherein the base is a square case; the flip cap comprises a first side provided with a second hinge shaft, and a second side provided with a fastener; and a clamping groove matching the fastener is formed in the base.

16. The replaceable powder palette according to claim 13, wherein the base is a square case; the flip cap comprises a first side provided with a second hinge shaft, and a second side provided with a fastener; and a clamping groove matching the fastener is formed in the base.

17. The replaceable powder palette according to claim 14, wherein one side of the dustproof cap is hinged to the base through a first hinge shaft; and the first hinge shaft and the second hinge shaft are a same shaft.

18. The replaceable powder palette according to claim 15, wherein one side of the dustproof cap is hinged to the base through a first hinge shaft; and the first hinge shaft and the second hinge shaft are a same shaft.

19. The replaceable powder palette according to claim 16, wherein one side of the dustproof cap is hinged to the base through a first hinge shaft; and the first hinge shaft and the second hinge shaft are a same shaft.

20. The replaceable powder palette according to claim 14, wherein one side of the dustproof cap is hinged to the base through a first hinge shaft; and the first hinge shaft and the second hinge shaft are hinged to adjacent edges of the base.
